(19) United States
(12) Patent Application Publication
(10) Pub. No.: US 2012/0133219 A1
(43) Pub. Date: May 31, 2012

(54) APPARATUS FOR GENERATING VIBRATIONS

(75) Inventors: Jung Taek Hong, Suwon (KR); Joon Choi, Suwon (KR)

(73) Assignee: SAMSUNG ELECTRO-MECHANICS CO., LTD.

(21) Appl. No.: 13/306,254

(22) Filed: Nov. 29, 2011

(30) Foreign Application Priority Data
Nov. 30, 2010 (KR) 10-2010-0120761

(51) Int. Cl. H02K 33/00

(52) U.S. Cl. 310/25

(57) ABSTRACT

There is provided an apparatus for generating vibrations, including: a housing forming an internal space; a flexible member disposed in the internal space of the housing and made of a soft material; a magnetic field unit disposed to be opposite to the flexible member and including a yoke having a magnet mounted therein to be moved, the magnet electromagnetically interacting with a coil; and a damper provided in the internal space of the housing to be disposed outside the coil and reducing movement sound generated due to the tilting of the yoke during upward and downward movement of the yoke.

### CROSS-REFERENCE TO RELATED APPLICATIONS

This application claims the priority of Korean Patent Application No. 10-2010-0120761 filed on Nov. 30, 2010, in the Korean Intellectual Property Office, the disclosure of which is incorporated herein by reference.

### BACKGROUND OF THE INVENTION

1. Field of the Invention

The present invention relates to an apparatus for generating vibrations, and more particularly, an apparatus for generating vibrations including a yoke moved by electromagnetic interaction between a coil and a magnet.

2. Description of the Related Art

A linear vibrator, a component converting electrical energy into mechanical vibrations using the principle of generating electromagnetic force, is mounted in an electronic apparatus such as a mobile communications terminal, a portable game machine, or the like, to be used for silently notifying a user of call reception by transferring vibrations thereto.

In accordance with the recent trend for compactness and slimness in mobile communications terminals, a compact, multi-functional linear vibrator has also been mounted therein.

A stator and a vibrator vibrated due to electromagnetic interaction therebetween are disposed in an internal space of the linear vibrator, according to the related art.

Since internal components configuring the vibrator and the stator are disposed in the internal space at a high level of density, interference is caused between the internal components due to the vibrations of the vibrator.

The interference between the internal components may cause problems such as the generation of noise, damage, or the like.

Accordingly, there has been demand for research into a linear vibrator capable of reducing noise or improving the lifespan of internal components thereof by removing interference between the internal components in spite of the internal components being disposed at a high level of density.

### SUMMARY OF THE INVENTION

An aspect of the present invention provides an apparatus for generating vibrations capable of reducing noise generated during the movement thereof.

According to an aspect of the present invention, there is provided a vibration generating apparatus, including: a housing forming an internal space; a flexible member mounted in the internal space of the housing and made of a soft material; a magnetic field unit disposed to be opposite to the flexible member and including a yoke having a magnet mounted therein to be moved, the magnet electromagnetically interacting with a coil; and a damper provided in the internal space of the housing to be disposed outside the coil and reducing movement sound generated due to the tilting of the yoke during upward and downward movement of the yoke.

The flexible member may be a flexible circuit board mounted in the housing.

The coil may be mounted on the flexile member and may have a cylindrical shape.

The yoke may include: a magnet fixing part fixing the magnet; a magnet fixing part fixing the magnet; a weight body fixing part bent from the magnet fixing part in a magnetizing direction of the magnet to fix a weight body; and a claw part formed to be bent from the weight body fixing part to support a bottom of the weight body.

The damper may be fixedly mounted on the claw part in order to prevent the weight body from contacting the housing due to the tilting of the yoke.

The damper may be mounted on the flexible member to be disposed such that it is opposite to the claw part in order to prevent the weight body from contacting the housing due to the tilting of the yoke.

The damper may have a ring shape in order to reduce the generation of movement sound due to the tilting of the yoke.

The magnetic field unit further includes a yoke plate mounted on an opposite side to a side on which the magnet and the yoke are in contact with each other.

The flexible member may be a film attached to a circuit board mounted in the housing.

The housing may include a cylindrical upper case of which a lower portion is open and a bracket closing the lower portion of the upper case and having the flexible member mounted thereon.

The coil may have a cylindrical shape so as to form a space in which the magnetic field unit is moved, and a first magnetic fluid preventing mutual contact between the magnetic field unit and the coil may be provided in a clearance therebetween.

The magnetic field unit may further include an elastic member having an edge fixedly bonded to the housing and the center fixedly bonded to the yoke to provide elastic force during the upward and downward movement of the yoke.

The elastic member may be made of a leaf spring mounted in the housing to provide the elastic force.

The elastic member may be provided with a second magnetic fluid in order to alleviate impact due to contact with the housing during the movement of the yoke.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a partially cut-away perspective view schematically showing an apparatus for generating vibrations according to an exemplary embodiment of the present invention;

FIG. 2 is a cross-sectional view schematically showing an apparatus for generating vibrations according to an exemplary embodiment of the present invention;

FIG. 3 is a view describing an operation of an apparatus for generating vibrations according to an exemplary embodiment of the present invention;

FIG. 4 is a cross-sectional view schematically showing an apparatus for generating vibrations according to another exemplary embodiment of the present invention;

FIG. 5 is a cross-sectional view schematically showing an apparatus for generating vibrations according to another exemplary embodiment of the present invention; and

FIG. 6 is a cross-sectional view schematically showing an apparatus for generating vibrations according to another exemplary embodiment of the present invention.

### DETAILED DESCRIPTION OF THE PREFERRED EMBODIMENT

Exemplary embodiments of the present invention will now be described in detail with reference to the accompanying drawings. However, it should be noted that the spirit of the present invention is not limited to the embodiments set forth herein and those skilled in the art and understanding the present invention can easily accomplish retrogressive inventions or other embodiments included in the spirit of the present invention by the addition, modification, and removal of components within the same spirit, but those are construed as being included in the spirit of the present invention.

Further, when it is determined that the detailed description of the known art related to the present invention may obscure the gist of the present invention, the detailed description thereof will be omitted.

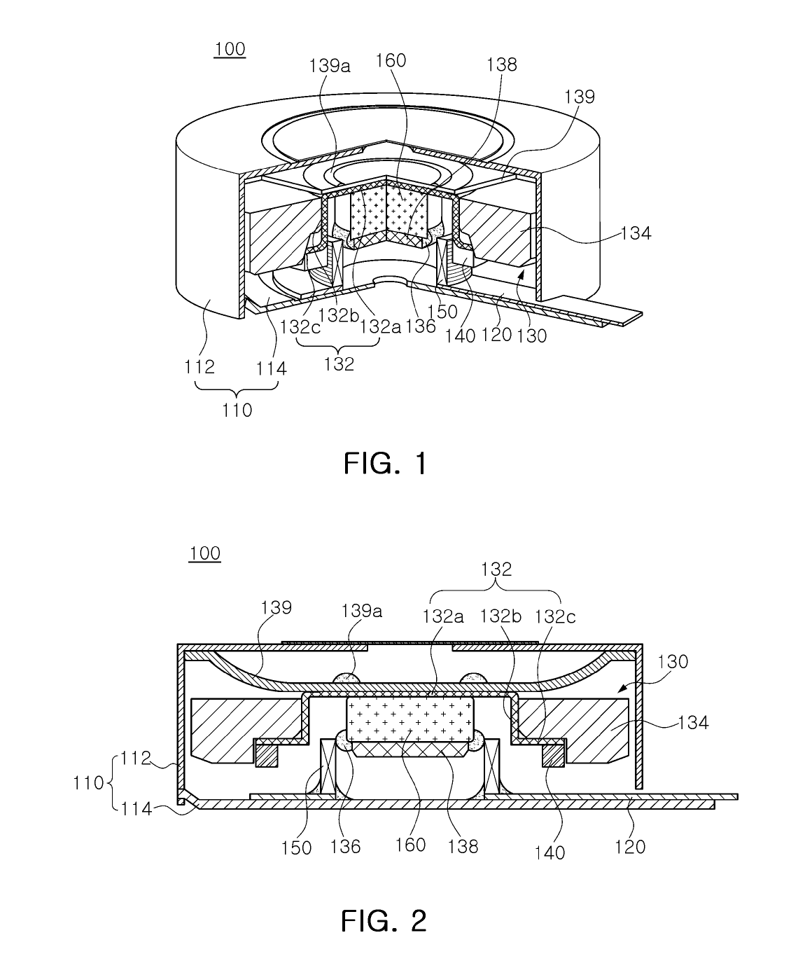

FIG. 1 is a partially cut-away perspective view schematically showing an apparatus for generating vibrations according to an exemplary embodiment of the present invention, and FIG. 2 is a cross-sectional view schematically showing an apparatus for generating vibrations according to an exemplary embodiment of the present invention.

Referring to FIGS. 1 and 2, an apparatus 100 for generating vibrations may be configured to include a housing 110, a flexible member 120, a magnetic field unit 130, and a damper 140.

Meanwhile, defining terms with respect to directions, an axial direction means a vertical direction in FIG. 1, a radial direction means a direction from the center of the housing 110 toward the outside of the housing 110 or a direction from the outside of the housing 110 toward the center of the housing 110 in FIG. 1, and a circumferential direction means a direction rotating around the outside of the housing 110.

The housing 110 forms an internal space. That is, the housing 110 is formed to have the internal space having a plurality of components disposed therein and may have various shapes and sizes.

Meanwhile, as an example, the housing 110 includes a cylindrical upper case 112 of which a lower portion is open and a bracket 114 closing the lower portion of the upper case 112 and made of a metal material.

The flexible member 120 is disposed in the internal space of the housing 110 and is made of a soft material. In addition, the flexible member 120 is disposed in the housing 110 and has a coil 150 mounted thereon. That is, the flexible member 120 is fixedly mounted on the bracket 114 of the housing 110, and is composed of a flexible circuit board having the coil 150 mounted on an upper surface thereof.

That is, since the flexible member 120 is composed of the flexible circuit board made of the soft material, when it contacts the damper 140, it may alleviate impact applied from the damper 140. Therefore, the generation of noise may be suppressed.

Meanwhile, the coil may have a hollow cylindrical shape.

The magnetic field unit 130 is disposed to be opposite to the flexible member 120, and may include a yoke 132 having a magnet 160 disposed therein to be moved, the magnet 160 electromagnetically interacting with the coil 150.

That is, the magnetic field unit 140 generates a magnetic field having a predetermine intensity, and may be configured to include the yoke 132 and the magnet 150, which are disposed in the internal space of the housing 110.

In addition, the yoke 132 may include a magnet fixing part 132a fixing the magnet 160, a weight body fixing part 132b bent from the magnet fixing part 132a in a magnetizing direction of the magnet 160 to fix a weight body 134, and a claw part 132c formed to be bent from the weight body fixing part 132b to support a bottom of the weight body 134.

Meanwhile, the magnet 160 may be bonded and fixed to the magnet fixing part 132a using an adhesive. A diameter of the magnet fixing part 132a is formed to be larger than that of the magnet 160, such that an air gap having a predetermine size may be formed between the weight body fixing part 132b and the magnet 160.

In addition, the magnet 160 may be inserted into a cylindrical hollow of the coil 150 during the upward and downward movement of the yoke 132. At this time, the coil 150 may be disposed in the air gap formed by the weight body fixing part 132b and the magnet 160.

Accordingly, the magnetic field formed by the magnet 160 and an electric field formed by allowing current to flow to the coil 150 interact to move the yoke 132 upwardly and downwardly, thereby generating vibrations.

Meanwhile, a first magnetic fluid 136 preventing mutual contact of the magnetic field unit 130 and the coil 150 may be provided in a clearance therebetween. That is, the first magnetic fluid 136 may be provided in the clearance formed between the magnetic field unit 160 and the coil 150.

In addition, the magnetic filed unit 130 may further include a yoke plate 138 mounted on an opposite side to a side on which the magnet 160 and the yoke 132 are in contact with each other.

The yoke plate 138 serves to smoothly form magnetic flux flowing to the magnet 160 through the coil 150 interacting with the magnet 160 to generate electromagnetic force.

In addition, the yoke plate 138 may be made of a magnetic material and also serves to smoothly apply the above-mentioned magnetic fluid 136.

Furthermore, the magnetic field unit 130 may further include an elastic member 139 having an edge fixedly bonded to the housing 110 and the center fixedly bonded to the yoke 132 to provide elastic force during the upward and downward movement of the yoke 132.

That is, the elastic member 139 has the edge fixedly bonded to the upper case 112 and the center fixedly bonded to the magnet fixing part 132 of the yoke 132 to provide the elastic force during the upward and downward movement of the yoke 132.

In addition, the elastic member may be made of a leaf spring providing the elastic force. Although an exemplary embodiment of the present invention describes a case in which the elastic member 139 is made of the leaf spring by way of example, the present invention is not limited thereto. For example, the elastic member 139 may be made of a coil spring.

Meanwhile, the elastic member 139 may be provided with a second magnetic fluid 139a in order to alleviate impact due to contact with the housing 110 during the movement of the yoke 132. That is, the second magnetic fluid 139a is provided on an upper surface of the elastic member 139 and serves to alleviate the impact by contacting a ceiling surface of the upper case 112 during the movement of the yoke 132.

The damper 140 suppresses the generation of movement sounds during the movement of the yoke 132, together with the flexible member 120 made of the soft material.

In addition, the damper 140 may be mounted on the yoke 132 by way of example. More specifically, the damper 140 may be fixedly mounted on the claw part 132c of the yoke 132 to be adjacent to the weight body 134.

Accordingly, the damper 140 contacts the flexible member 120 made of the soft material rather than contacting the bracket 114 made of the metal material during the upward and downward movement of the yoke 132, whereby the generation of the movement sound during the upward and downward movement of the yoke 132 may be suppressed.

Meanwhile, the damper 140 may be made of a rubber material in order to alleviate the impact. However, the material of the damper 140 is not limited thereto but the damper 140 may be made of any material if the material is the soft material capable of alleviating the impact applied from the yoke 132 to suppress the movement sound.

In addition, the damper 140 may reduce contact between the weight body 134 and the bracket 114 due to the vibrations of the yoke 132 during the upward and downward movement of the yoke 132.

More specifically, when the yoke 132 is moved upwardly and downwardly, it is moved in this manner while being vertically tilted, based on a portion at which the yoke 132 and the elastic member 139 are bonded to each other. However, since the damper 140 is mounted on the yoke 132 to be disposed outside the coil 150 in the radial direction, with relation to the center of the yoke 132, even in the case that the yoke 132 is moved upwardly and downwardly while being finely vibrated, contact between the edge of the weight body 134 and the bracket 114 may be reduced.

Meanwhile, the damper 140 has a height such that a bottom thereof may be disposed to be lower than the weight body 134 when it is mounted on the yoke 132. That is, the damper 140 is protruded downwardly from the weight body 134 so that the weight body 134 may not contact the bracket 114 or the flexible member 120.

As described above, the damper 140 serving to reduce the impact and the noise may reduce the noise generated during the upward and downward movement of the magnetic field unit 130 together with the flexible member 120 and may thus effectively suppress the generation of the noise.

That is, when the yoke 132 of the magnetic field unit 130 is moved upwardly and downwardly, the noise generated by the yoke 132 and the bracket 114, which are made of the metal material, may be removed. Furthermore, the damper 140 contacts the flexible circuit board, which is the flexible member 120, whereby the movement sound generated during the upward and downward movement of the yoke 132 may be suppressed.

In addition, since the damper 140 has a ring shape and is mounted on the yoke 132 to be disposed outside the coil 150, even in the case in which the yoke 132 is moved upwardly and downwardly, while being finely vibrated, the contact between the weight body 134 and the bracket 114 may be reduced to reduce the generation of the movement sound.

Hereinafter, an operation of an apparatus for generating vibrations according to an exemplary embodiment of the present invention will be described with reference to the accompanying drawings.

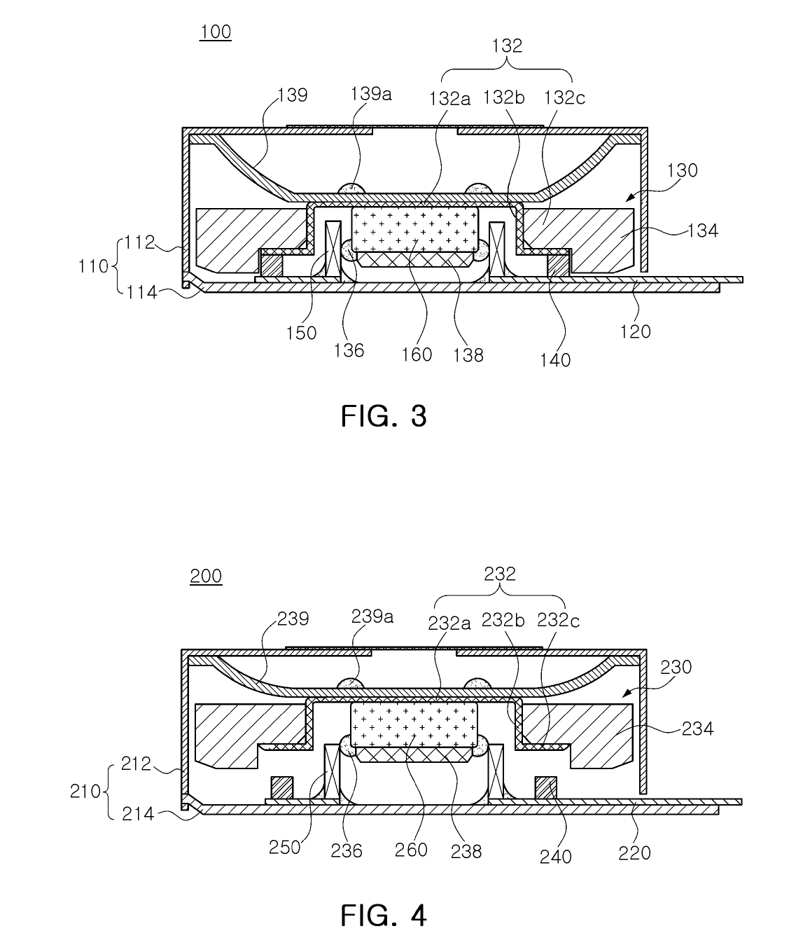

FIG. 3 is a view describing an operation of an apparatus for generating vibrations according to an exemplary embodiment of the present invention.

First, when power is supplied to the coil 150 mounted on the flexible circuit board, which is the flexible member 120, the yoke 132 is moved upwardly and downwardly by the electromagnetic interaction between the magnet 150 disposed in the yoke 132 and the coil 150.

At this time, the yoke 132 is repetitively moved upwardly and downwardly by the elastic force of the elastic member 139 to generate the vibrations.

Meanwhile, when the yoke 132 is moved downwardly, it is moved downwardly until the damper 140 mounted on the yoke 132 contacts the flexible circuit board, which is the flexible member 120, as shown in FIG. 4. That is, the damper 140 made of the rubber material contacts the flexible member 120 made of the soft material, whereby the generation of the movement sound may be suppressed, as compared to a case in which the damper 140 contacts the bracket 114 made of the metal material.

In addition, the yoke 132 is moved upwardly and downwardly, while being vertically tilted based on the portion at which the yoke 132 and the elastic member 139 are bonded to each other. However, since the damper 140 is mounted on the yoke 132 to be disposed outside the coil 150 in the radial direction from the center of the yoke 132, even in the case in which the yoke 132 is moved upwardly and downwardly, while being finely vibrated, the contact between the edge of the weight body 134 and the bracket 114 may be reduced.

Hereinafter, an operation of an apparatus for generating vibrations according to another exemplary embodiment of the present invention will be described with reference to the accompanying drawings. However, a detailed description of the same components as the above-mentioned components will be omitted.

FIG. 4 is a cross-sectional view schematically showing an apparatus for generating vibrations according to another exemplary embodiment of the present invention.

Referring to FIG. 4, an apparatus 200 for generating vibrations according to another exemplary embodiment of the present invention may be configured to include a housing 210, a flexible member 220, a magnetic field unit 230, and a damper 240.

Meanwhile, the housing 210, the flexible member 220, and the magnetic field unit 230 correspond to the same components as the housing 110, the flexible member 120, and the magnetic field unit 130 included in the apparatus for generating vibrations according to the exemplary embodiment of the present invention as described above. Therefore, a detail description thereof will be omitted.

Hereinafter, the damper 240 will be described.

The damper 240 is fixedly mounted on the flexible member 220 which is fixedly mounted on a bracket 214 of the housing 210. More specifically, the damper 240 is fixedly mounted on the flexible member 220 so that it may contact the edge of a claw part 232c of a yoke 232 when the yoke 232 is moved downwardly.

Accordingly, the impact applied by the yoke 232 during the downward movement of the yoke 232 may be alleviated and transferred to the bracket 214 of the housing 210 through the damper 240 and the flexible member 220, and the generation of the movement sound by the yoke 232 and the bracket 214 may also be reduced.

In addition, since the damper 240 is mounted on the flexible member 220 to be disposed outside a coil 250, even in the case in which the yoke 232 is moved upwardly and downwardly, while being tilted, the noise generated due to the contact between a weight body 234 and the bracket 214 may be suppressed.

Hereinafter, an operation of an apparatus for generating vibrations according to another exemplary embodiment of the present invention will be described with reference to the accompanying drawings. However, a detailed description of the same components as the components included in the apparatus for generating vibrations according to the exemplary embodiment of the present invention as described above will also be omitted.

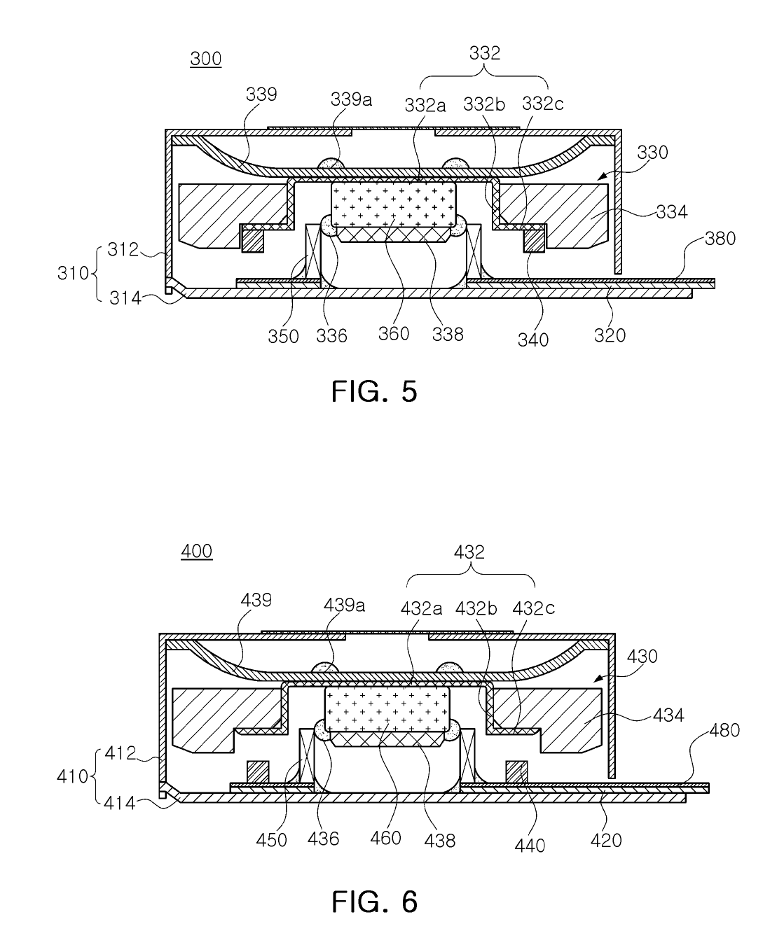

FIG. 5 is a cross-sectional view schematically showing an apparatus for generating vibrations according to another exemplary embodiment of the present invention.

Referring to FIG. 5, an apparatus 300 for generating vibrations according to another exemplary embodiment of the present invention may be configured to include a housing 310, a flexible member 320, a magnetic field unit 330, and a damper 340.

Meanwhile, the magnetic field unit 330 and the damper 340 of the apparatus 300 for generating vibrations according to another exemplary embodiment of the present invention correspond to the same components as the magnetic field unit 130 and the damper 140 of the apparatus 100 for generating vibrations according to the exemplary embodiment of the present invention as described above. Therefore, a detail description thereof will be omitted.

The housing 310 forms an internal space. That is, the housing 310 is formed to have the internal space having a plurality of components disposed therein and may have various shapes and sizes.

Meanwhile, as an example, the housing 310 includes a cylindrical upper case 312 of which a lower portion is open and a bracket 314 closing the lower portion of the upper case 312 and made of a metal material.

In addition, a circuit board 316 having a coil 350 mounted thereon is fixedly mounted on the bracket 314.

The flexible member 320 is mounted in the internal space of the housing 310 and is made of a soft material. In addition, the flexible member 320 may be a film attached to the circuit board 316 by way of example.

Meanwhile, the flexible member 320 may be changed into any component capable of being mounted on the circuit board 216 to reduce the movement sound generated by a yoke 332 and the bracket 314 during the downward movement of the yoke 332.

As described above, even in the case in which the damper 340 is moved downwardly to contact the flexible member 320, the impact may be alleviated by the flexible member 320 made of the soft material to be transferred to the bracket 314, whereby the movement sound generated when the yoke 332 is moved downwardly to contact the damper 340 with a lower side thereof may be reduced.

Hereinafter, an apparatus 400 for generating vibrations according to another exemplary embodiment of the present invention will be described with reference to the accompanying drawings. However, a detailed description of the same components as the above-mentioned components will be omitted.

FIG. 6 is a cross-sectional view schematically showing an apparatus for generating vibrations according to another exemplary embodiment of the present invention.

Referring to FIG. 6, an apparatus 400 for generating vibrations according to another exemplary embodiment of the present invention may be configured to include a housing 410, a flexible member 420, a magnetic field unit 430, and a damper 440.

Meanwhile, the magnetic field unit 430 and the damper 440 correspond to the same components as the magnetic field unit 230 and the damper 240 included in the apparatus 200 for generating vibrations according to another exemplary embodiment of the present invention as described above. Therefore, a detail description thereof will be omitted.

The housing 410 forms an internal space. That is, the housing 410 is formed to have the internal space having a plurality of components disposed therein and may have various shapes and sizes.

Meanwhile, as an example, the housing 410 includes a cylindrical upper case 412 of which a lower portion is open and a bracket 412 closing the lower portion of the upper case 414 and made of a metal material.

In addition, a circuit board 416 having a coil 450 mounted thereon is fixedly mounted on the bracket 414.

The flexible member 420 is mounted in the internal space of the housing 410 and is made of a soft material. In addition, the flexible member 420 may be a film attached to the circuit board 416 by way of example.

Meanwhile, the flexible member 420 may be changed into any component capable of being mounted on the circuit board 416 to reduce the movement sound generated by a yoke 432 and the bracket 414 during the downward movement of the yoke 432.

As described above, even in the case in which the damper 440 is moved downwardly to contact the flexible member 420, the impact may be alleviated by the flexible member 420 made of the soft material to be transferred to the bracket 414, whereby the movement sound generated when the yoke 432 is moved downwardly to contact the damper 440 with a lower side thereof may be reduced.

The damper 440 is fixedly mounted on the flexible member 420 which is fixedly mounted on the circuit board 416 of the bracket 414. More specifically, the damper 440 is fixedly mounted on the flexible member 420 so that it may contact the edge of a claw part 432c of a yoke 432 when the yoke 432 is moved downwardly.

Accordingly, the impact applied by the yoke 432 during the downward movement of the yoke 432 may be alleviated and transferred to the bracket 414 of the housing 410 through the damper 440 and the flexible member 420, and the generation of the movement sound by the yoke 432 and the bracket 414 may also be reduced.

In addition, since the damper 440 is mounted on the flexible member 420 to be disposed outside a coil 450, even in the case in which the yoke 432 is moved upwardly and downwardly, while being tilted, the noise generated due to the contact between a weight body 432 and the bracket 414 may be suppressed.

As set forth above, according to the exemplary embodiments of the present invention, the damper serving to reduce the impact and the noise may reduce the noise generated during the upward and downward movement of the magnetic field unit together with the flexible member, whereby the generation of noise may be effectively suppressed.

In addition, according to the exemplary embodiments of the present invention, the damper is disposed outside the coil to reduce contact between the weight body and the bracket due to tilting of the yoke during the upward and downward movement of the yoke, whereby the generation of movement sound, that is, noise may be suppressed.

While the present invention has been shown and described in connection with the exemplary embodiments, it will be apparent to those skilled in the art that modifications and variations can be made without departing from the spirit and scope of the invention as defined by the appended claims.

What is claimed is:

1. An apparatus for generating vibrations, comprising:
a housing forming an internal space;
a flexible member mounted in the internal space of the housing and made of a soft material;
a magnetic field unit disposed to be opposite to the flexible member and including a yoke having a magnet mounted therein to be moved, the magnet electromagnetically interacting with a coil; and
a damper provided in the internal space of the housing to be disposed outside the coil and reducing movement sound generated due to the tilting of the yoke during upward and downward movement of the yoke.

2. The apparatus for generating vibrations of claim 1, wherein the flexible member is a flexible circuit board mounted in the housing.

3. The apparatus for generating vibrations of claim 2, wherein the coil is mounted on the flexile member and has a cylindrical shape.

4. The apparatus for generating vibrations of claim 1, wherein the yoke includes:
a magnet fixing part fixing the magnet;
a weight body fixing part bent from the magnet fixing part in a magnetizing direction of the magnet to fix a weight body; and
a claw part formed to be bent from the weight body fixing part to support a bottom of the weight body.

5. The apparatus for generating vibrations of claim 4, wherein the damper is fixedly mounted on the claw part in order to prevent the weight body from contacting the housing due to the tilting of the yoke.

6. The apparatus for generating vibrations of claim 4, wherein the damper is mounted on the flexible member to be disposed such that it is opposite to the claw part in order to prevent the weight body from contacting the housing due to the tilting of the yoke.

7. The apparatus for generating vibrations of claim 5 or 6, wherein the damper has a ring shape in order to reduce the generation of movement sound due to the tilting of the yoke.

8. The apparatus for generating vibrations of claim 4, wherein the magnetic field unit further includes a yoke plate mounted on an opposite side to a side on which the magnet and the yoke are in contact with each other.

9. The apparatus for generating vibrations of claim 1, wherein the flexible member is a film attached to a circuit board mounted in the housing.

10. The apparatus for generating vibrations of claim 1, wherein the housing includes a cylindrical upper case of which a lower portion is open and a bracket closing the lower portion of the upper case and having the flexible member mounted thereon.

11. The apparatus for generating vibrations of claim 1, wherein the coil has a cylindrical shape so as to form a space in which the magnetic field unit is moved, and a first magnetic fluid preventing mutual contact between the magnetic field unit and the coil is provided in a clearance therebetween.

12. The apparatus for generating vibrations of claim 1, wherein the magnetic field unit further includes an elastic member having an edge fixedly bonded to the housing and the center fixedly bonded to the yoke to provide elastic force during the upward and downward movement of the yoke.

13. The apparatus for generating vibrations of claim 12, wherein the elastic member is made of a leaf spring mounted in the housing to provide the elastic force.

14. The apparatus for generating vibrations of claim 12, wherein the elastic member is provided with a second magnetic fluid in order to alleviate impact due to contact with the housing during the movement of the yoke.
